(19) United States
(12) Patent Application Publication
(10) Pub. No.: US 2009/0080968 A1
(43) Pub. Date: Mar. 26, 2009

(54) BICYCLE SEAT TUBE CLAMP AND ASSOCIATED METHODS

(75) Inventors: David Michael Parrett, Macon, GA (US); Troy Nathan Boston, Cochran, GA (US); Eric Reid Lassiter, Monroe, GA (US); Mark Patrick McJunkin, Atlanta, GA (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: L.H. THOMSON COMPANY, INC., Macon, GA (US)

(21) Appl. No.: 11/860,852

(22) Filed: Sep. 25, 2007

(51) Int. Cl. B62K 19/36

(52) U.S. Cl. 403/290

(57) ABSTRACT

A bicycle seat tube clamp may include a clamp body having an opening for a bicycle seat tube. The clamp body may have a separation defining first and second opposing clamp ends which may have respective first and second aligned fastener shaft-receiving passageways therein. The first clamp end may have a cylindrically shaped nut-receiving passageway intersecting the first fastener shaft-receiving passageway. The second clamp end may have an enlarged fastener head-receiving passageway aligned with the second fastener shaft-receiving passageway. The clamp may also include a fastener having an enlarged head with a convex lower surface. A cylindrically shaped nut may be positioned in the nut-receiving passageway and engage the fastener shaft. A shaped washer may surround the shaft and have a concave upper surface engaging the convex lower surface of the fastener head. Alternatively, the concave surface may be integrally formed in the enlarged fastener head-receiving passageway.

### FIELD OF THE INVENTION

The present invention relates to the field of bicycle components, and, more particularly, to a bicycle seat tube clamp for securing a bicycle seat post within a bicycle frame seat tuber and associated methods.

### BACKGROUND OF THE INVENTION

Bicycles are popular for both transportation and particularly for recreation and exercise. High performance off-road bicycles, also called mountain bikes, are widely used for traversing rugged terrain. Like a touring bicycle, a mountain bicycle desirably has a low weight to reduce rider fatigue. Accordingly, the frame and components of the bicycle are desirably light in weight, yet sufficiently strong to reduce the likelihood of damage to the bicycle. The frame and other components of a mountain bike, in particular, may be subjected to very high loads caused by intentional, as well as unintentional jumps, falls, or drops.

A typical bicycle includes a tubular frame having a seat tube to receive a seat post, and a seat tube clamp to secure the seat post within the seat tube. The seat post typically includes a tubular body to be inserted into the seat tube, and a clamp carried by the upper end of the tube to which the bicycle seat rails are secured. A seat tube clamp positioned around the upper portion of the seat tube grips onto the seat post to secure the seat post within the seat tube. The height of the seat relative to the bicycle frame is readily adjustable between minimum and maximum positions for the rider's comfort by loosening the seat tube clamp, adjusting the extension of the seat post, and then tightening the seat tube clamp around the seat tube. The seat tube clamp is desirably lightweight like most bicycle components, but is also desirably strong to secure the seat post within the seat tube even under heavy load conditions.

One type of seat tube clamp is a quick release clamp having a lever operated cam tightening arrangement. The bicycle seat height can be adjusted without using tools by the rider by manipulating the lever. Unfortunately, a quick release clamp may not provide sufficient gripping strength, such as needed for many types of bicycle riding.

U.S. Pat. No. 6,676,095 to Dal Pra' also discloses a bicycle seat clamp with an opening in the annular seat clamp body offset from the center axis, and having a separation defining first and second opposing clamp ends. The first and second opposing clamp ends have respective diagonally oriented first and second aligned fastener shaft-receiving passageways therein. Tightening the fastener brings the opposing clamp ends together at an angle to secure the seat post to the seat tube.

Unfortunately, such a seat tube clamp with a threaded fastener may exhibit binding as the clamp is tightened. Binding may occur as the fastener head and nut are subject to rotation as the clamp ends are brought together. The fastener shaft may also bind against the passageways as the clamp ends are brought together. Accordingly, the tightening torque is not completely transferred to the overall gripping power, but rather a portion of it is lost in overcoming the binding.

The Sette Model ST-204 seat tube clamp, from Sette USA a division of Primo Design Importers Ltd. Of Las Vegas, Nev., includes an asymmetrical annular body portion with an opening therethrough defined for receiving the upper end of the seat tube of the bicycle. The annular clamp body has a diagonal separation therein defining first and second opposing clamp ends. A fastener shaft intersects the first and second clamp ends. A threaded barrel nut is in the second clamp end. As the seat tube clamp is tightened by the fastener, the opposing clamp ends draw toward each other. The barrel nut allows rotational movement as the clamp is tightened. Although the barrel nut may improve overall fastener binding within the fastener passageway, there is still binding on the fastener head side of the clamp between the fastener head and the clamp, and there may still be binding in the fastener-receiving passageway.

### SUMMARY OF THE INVENTION

In view of the foregoing background, it is therefore an object of the present invention to provide a bicycle seat tube clamp that is lightweight, strong, and may have reduced fastener binding.

This and other objects, features, and advantages in accordance with the present invention are provided by a bicycle seat tube clamp for clamping an open upper end of a seat tube of a bicycle onto a bicycle seat post positioned therein. More particularly, the bicycle seat tube clamp may comprise a clamp body having an opening therethrough for receiving the upper end of the seat tube of the bicycle. At least one radially inwardly extending projection may be carried by the clamp body for engaging the upper end of the seat tube. The clamp body may have a separation therein defining first and second opposing clamp ends. The first and second opposing clamp ends may have respective first and second aligned fastener shaft-receiving passageways therein. The first clamp end may further have a nut-receiving passageway intersecting the first fastener shaft-receiving passageway. The nut-receiving passageway may have at least a partial cylindrical shape. The second clamp end may include an enlarged fastener head-receiving passageway aligned with the second fastener shaft-receiving passageway, for example.

A fastener may be included and may comprise an enlarged head positioned in the enlarged fastener head-receiving passageway. The enlarged head may have a convex lower surface. A shaft may extend outwardly from the enlarged head and may be positioned to extend through the first and second fastener shaft-receiving passageways. A nut may also be positioned in the nut-receiving passageway and may engage the shaft. The nut may have at least a partial cylindrical shape.

In one embodiment, a shaped washer may surround the shaft and have a concave upper surface engaging the convex lower surface of the enlarged fastener head. In another embodiment, the concave surface may be provided by adjacent integrally formed clamp body portions defining the enlarged fastener head-receiving passageway. Accordingly, this arrangement advantageously prevents or reduces the fastener binding within the passageway thus resulting in smoother tightening. Yet, a further advantage is that the fastener torque is applied to overall gripping power rather than to overcoming binding. The convex lower surface of the enlarged head may have a spherical shape, and the concave upper surface of the shaped washer, or enlarged fastener head-receiving passageway, may have a conical shape, for example.

The clamp body may have a circular perimeter, and the opening through the clamp body may be offset from center defined by the circular perimeter so that the first and second clamp ends each has an enlarged thickness. Accordingly, the offset opening configuration may reduce the clamp body material thereby reducing the overall clamp weight.

In accordance with another advantageous feature, the first and second shaft-receiving passageways may be canted with respect to a centerline therethrough prior to tightening of the fastener. The canting helps to reduce the binding between the fastener and the fastener-receiving passageway as the clamp is tightened.

The first and second clamp ends each may also include a respective interior relief area. Accordingly, one advantage of the interior relief areas is to reduce potential damage to the bicycle seat tube while tightening the clamp. This may be especially advantageously when the seat clamp is used with a carbon fiber bicycle frame and/or seat post.

The at least one radially inwardly extending projection may comprise a ring having a separation therein aligned with the separation in the clamp body. The nut-receiving passageway may be a blind opening that is closed on the top to prevent the entry and accumulation of dirt and debris. The clamp body may comprise aluminum, for example.

Another aspect of the invention relates to a method for making a bicycle seat tube clamp for clamping an open upper end of a seat tube of a bicycle onto a bicycle seat post positioned therein. The method may include forming a clamp body to have an opening therethrough for receiving the upper end of the seat tube of the bicycle, and forming at least one radially inwardly extending projection carried by the clamp body for engaging the upper end of the seat tube. The method may also include forming a separation in the clamp body defining first and second opposing clamp ends, forming first and second opposing clamp ends to have respective first and second aligned fastener shaft-receiving passageways therein, and forming a first clamp end to further have a nut-receiving passageway intersecting the first fastener shaft-receiving passageway. The nut-receiving passageway may be formed to have at least a partial cylindrical shape.

The method may further include forming a second clamp end further having an enlarged fastener head-receiving passageway aligned with the second fastener shaft-receiving passageway. In addition, the method may include providing a fastener comprising an enlarged head positioned in the enlarged fastener head-receiving passageway and having a convex lower surface. A shaft extending outwardly from the enlarged head and positioned to extend through the first and second fastener shaft-receiving passageways may also be included with the fastener. A nut in the nut-receiving passageway may be included with the fastener to engage the shaft, and the nut may be formed to have at least a partially cylindrical shape. A shaped washer may also be included with the fastener to surround the shaft and have a concave upper surface to engage the convex lower surface of the enlarged fastener head. In other embodiments, the concave upper surface may be provided by adjacent integrally formed clamp body portions defining the enlarged fastener head-receiving passageway, and, accordingly, the shaped washer is not needed in these embodiments.

### BRIEF DESCRIPTION OF THE DRAWINGS

FIG. 1 is a side elevation view of a portion of a bicycle including a seat tube clamp in accordance with the present invention.

FIG. 2 is a perspective exploded view of the bicycle seat tube clamp as shown in FIG. 1.

FIG. 3 is a cross-sectional view of the clamp body of the bicycle seat tube clamp as shown in FIG. 1.

FIG. 4 is a top plan view of the bicycle seat tube clamp as shown in FIG. 1.

FIG. 5 is an enlarged partial cross-sectional view of the fastener-washer engagement of the bicycle seat tube clamp as shown in FIG. 1.

FIG. 6 is an enlarged partial cross-sectional view of the clamp body ends and fastener of the bicycle seat tube clamp as shown in FIG. 1.

FIG. 7 is an enlarged partial cross-sectional view of the clamp body ends and fastener of a bicycle seat tube clamp as in the prior art.

FIG. 8 is an enlarged partial cross-sectional view of engagement between the fastener and enlarged fastener head-receiving passageway in accordance with another embodiment of the bicycle seat tube clamp of the invention.

FIGS. 9 and 10 are enlarged cross-sectional views of the clamp ends of the clamp body as shown in FIG. 1 prior to and after clamp tightening, respectively.

FIG. 11 is an enlarged cross-section view of the clamp ends of the clamp body as shown in FIG. 1 after tightening and illustrating other aspects of the clamp.

### DETAILED DESCRIPTION OF THE PREFERRED EMBODIMENTS

The present invention will now be described more fully hereinafter with reference to the accompanying drawings in which preferred embodiments of the invention are shown. This invention may, however, be embodied in many different forms and should not be construed as limited to the illustrated embodiments set forth herein. Rather, these embodiments are provided so that this disclosure will be thorough and complete, and will fully convey the scope of the invention to those skilled in the art. Like numbers refer to like numbers throughout, and prime notation is used to indicate similar elements in alternative embodiments.

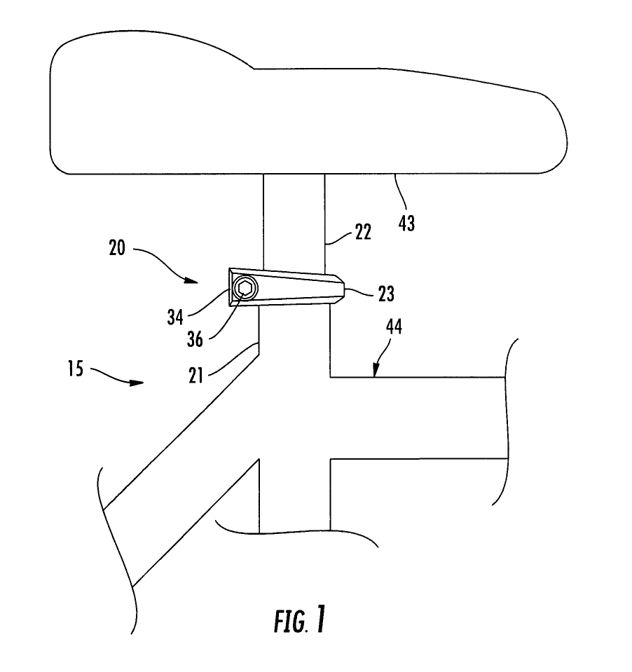

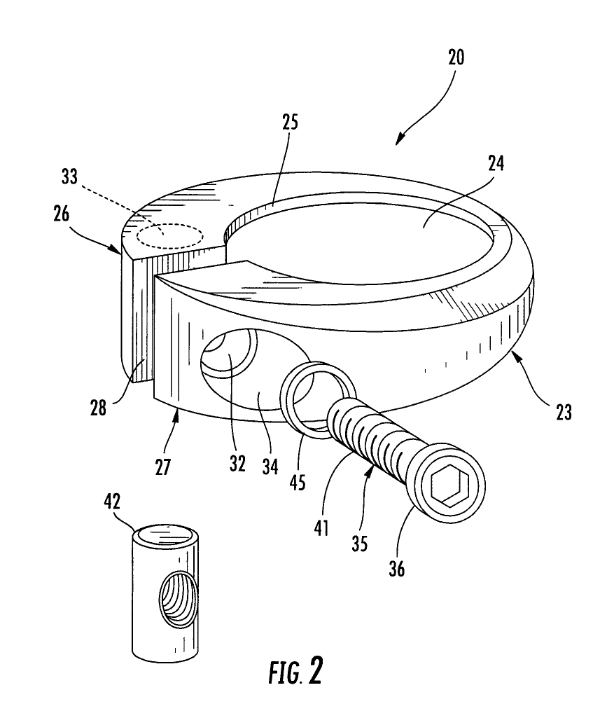

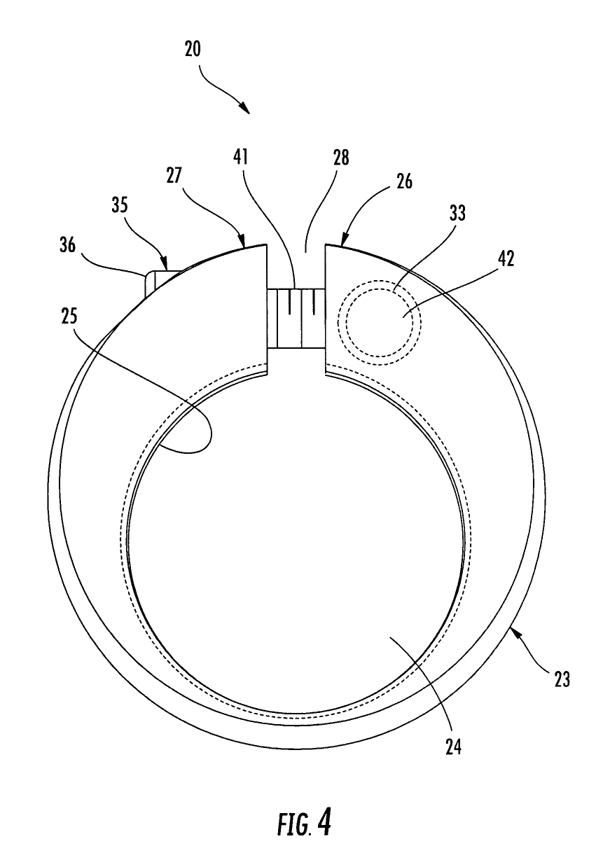

Referring initially to FIGS. 1-4, a bicycle seat tube clamp 20 in accordance with the present invention is described. The bicycle seat tube clamp 20 is for a bicycle 15 including a seat tube 21 having an open upper end receiving a bicycle seat post 22 therein. The seat tube 21 is formed as part of the bicycle frame 44. A bicycle seat 43 is carried by the upper end of the seat post 22.

The bicycle seat tube clamp 20 illustratively comprises a clamp body 23 having an opening therethrough 24 for receiving the upper end of the seat tube 21 of the bicycle. In the illustrated embodiment, the clamp body 23 has an annular shape, but may have other shapes in other embodiments. The clamp body 23 of the bicycle seat tube clamp 20 has rounded-over upper and lower outer edge portions to reduce weight and provide a smooth surface for the users protection. The clamp body 23 may comprise aluminum, although it may be formed of other lightweight and strong materials, for example.

A radially inwardly extending projection in the form of a ring 25 is carried by the clamp body 23 for engaging the upper end of the seat tube 21. The inwardly extending ring 25 holds the seat tube clamp 20 in its proper position on the seat tube 22 before it is tightened, for example. Of course, the radially inwardly extending projection may also have other shapes that prevent movement of the seat tube clamp 20 as will be appreciated by those skilled in the art.

The clamp body 23 has a separation 28 therein defining a first clamp end 26 and a second opposing clamp end 27. The opening 24 through the clamp body 23 is illustratively offset from center so that the first and second end portions 26, 27 have an enlarged thickness as compared to an opposite side of the clamp body 23. In the illustrated embodiment, the first and second clamp ends 26, 27 also have a greater height dimension than the opposing thinned side of the clamp body 23, again to reduce weight while maintaining strength.

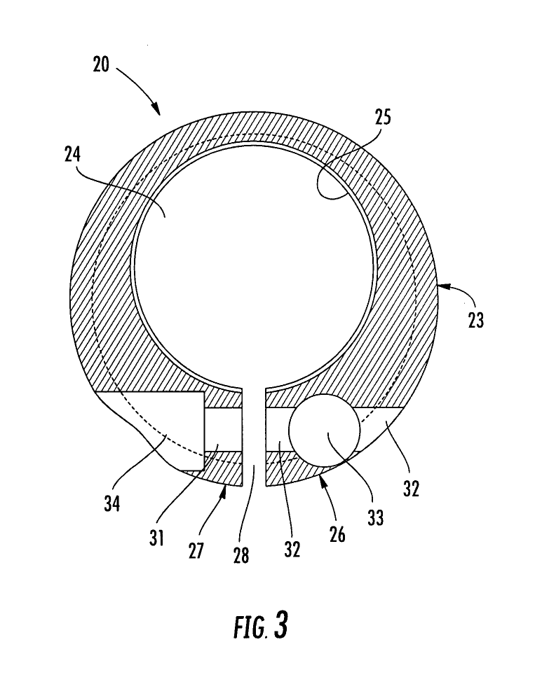

The first and second opposing clamp ends 26, 27 illustratively have respective first and second aligned fastener shaft-receiving passageways therein 31, 32 (FIG. 3). The first and second fastener shaft-receiving passageways 31, 32 are each vertically centered between upper and lower outer surfaces of the clamp body 23 in the illustrated embodiment. The first clamp end 26 has a nut-receiving passageway 33 intersecting the first fastener shaft-receiving passageway 31. The nut-receiving passageway 33 is illustratively in the form of a blind opening having a closed upper end to prevent the entry of dirt and debris as will be appreciated by those skilled in the art.

The second clamp end 27 has an enlarged fastener head-receiving passageway 34 aligned with the second fastener shaft-receiving passageway 32. A fastener 35 comprising an enlarged head 36 is positioned in the enlarged fastener head-receiving passageway 34.

The bicycle seat tube clamp 20 illustratively has a circular perimeter. Having a circular perimeter advantageously facilitates manufacturing of the clamp since it can be cut from a single disk or rod of starting material. As noted above the opening 24 through the clamp body 23 is offset from center so that the first and second end portions 26, 27 have an enlarged thickness. The offset opening 24 reduces the overall weight of the seat tube clamp 20. The bicycle seat tube clamp 20 may also have a weight reduction cavity or cavities contained within the clamp body 23, not shown. The cavities may be positioned to open outwardly to the bottom of the seat tube clamp 20 so that they are not visible from the top, and so that water does not collect in the cavities. Accordingly, each cavity also reduces the overall weight of the seat tube clamp 20.

A barrel nut 42 is illustratively positioned in the nut-receiving passageway 33 and engages the fastener shaft 41. Although a barrel nut 42 is used in the illustrated embodiment, other nuts having at least a partial cylindrical shape may also be used. Moreover, the barrel nut 42, or any nut having at least a partial cylindrical shape, allows partial rotational movement as will be appreciated by those skilled in the art. Accordingly, at least a partial cylindrical nut advantageously prevents or reduces fastener binding within the passageway thus resulting in smoother tightening. Also, the fastener torque is applied to overall gripping power rather than to overcoming binding.

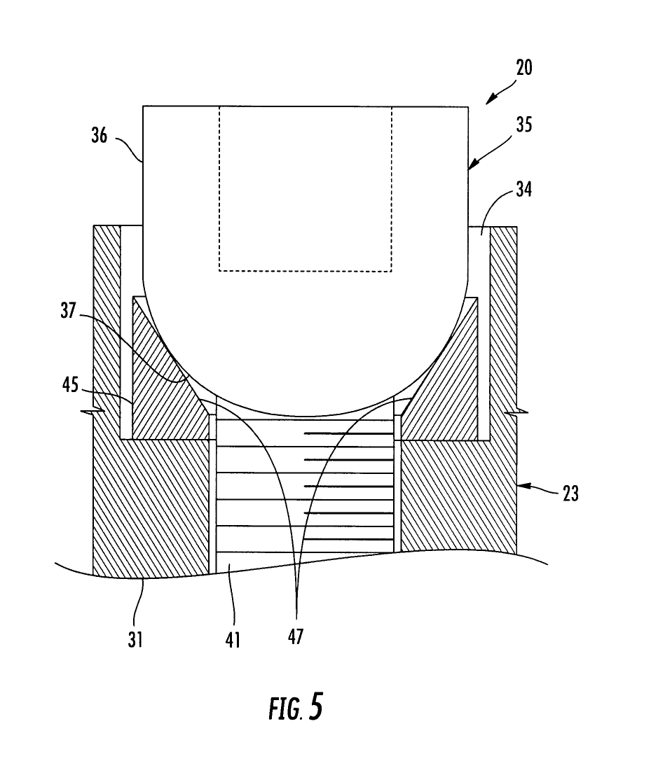

Referring now additionally to FIGS. 5 and 6, the enlarged head 36 illustratively has a convex lower surface 37. For example, the convex lower surface 37 may be in the shape of a partial sphere as shown in the illustrated embodiment. Indeed the width of the fastener head 36 may be equal to two times the radius of curvature as shown in the illustrated embodiment, although in other embodiments, the width may be greater or smaller that this figure. A shaft 41 extends outwardly from the enlarged head 36 and is positioned to extend through the first and second fastener shaft-receiving passageways 31, 32.

The bicycle seat tube clamp 20 includes a shaped washer 45 surrounding the shaft 41 of the fastener 35 and has a concave upper surface 47. The concave upper surface 47 engages the convex lower surface 37 of the enlarged fastener head 36 which may help reduce fastener binding. The concave upper surface 47 of the shaped washer 45 may be a conical surface such as shown perhaps best in FIG. 5. The shaped washer 45 may be made of steel, for example, or any other suitable material. The contact area between the shaped washer 45 and the enlarged head 36 may be about two-thirds the distance from the shaft 41 to the outer edge of the enlarged head 36, for example. The convex lower surface 37 of the enlarged head 36 and concave upper surface 47 of shaped washer 45 accommodate movement on the fastener head side of the clamp and reduce binding.

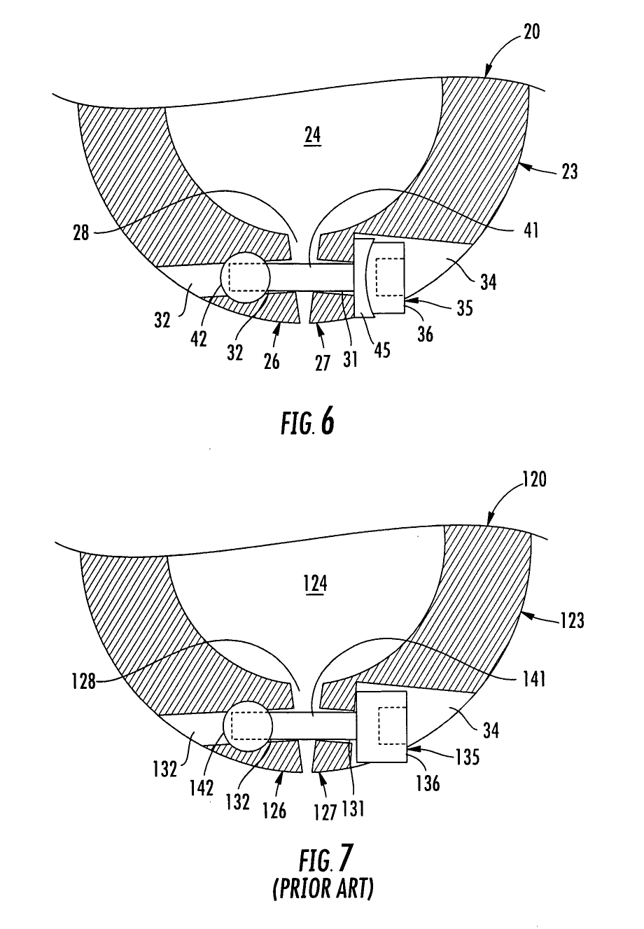

The rotating, pivotal, or mutating movement maybe accommodated by the shaped washer 45 and the enlarged head 35 may be perhaps best understood with comparative reference between FIGS. 6 and 7. In FIG. 7 a prior art clamp 120 is shown with similar parts to those in FIG. 6 indicated by reference numbers incremented by a hundred for ease of explanation. In the prior art clamp 120 shown in FIG. 7, there is no shaped washer 45 as in the clamp 20 shown in FIG. 6. Accordingly, the fastener head 136 becomes cocked during tightening, thereby tending to dig into the adjacent clamp body portions resulting fastener binding as the fastener is tightened, unlike the clamp 20 of the present invention shown in FIG. 6.

The clamp 20 according to the invention benefits from the rotating of the barrel nut 42 and the ability of the enlarged head 36 to swivel in or at the interface with the shaped washer 45. Binding of the fastener threads is reduced, and the enlarged head 36 is able to make uniform contact for 360 degrees of rotation around the shoulder of the head 36 as the clamp ends 26, 27 are drawn together. Further, more of the torque and fastener strength is applied to tightening of the clamp 20 and less on fastener binding. The fastener 35 will also be stressed in more of a pure tension fashion than tension in combination with bending. This makes the fastener 35 stronger, and/or a smaller fastener may be used. The clamp forces of will have a more proportional relationship to the torque used to tighten the fastener. This means that if the fastener is tightened by using a torque wrench, then the force squeezing on the seat tube and seat post is within a smaller band. This may be especially helpful for a carbon fiber bicycle frame and/or seat post. A rider may set a smaller torque value and still be sure the clamp will be tight enough. With the uniform force applied around the head 36 of the fastener 35, the fastener and the clamp body 23, especially at its ends 26, 27, can be made smaller and lighter to save weight. The components will accordingly have less stress concentrations and may last longer.

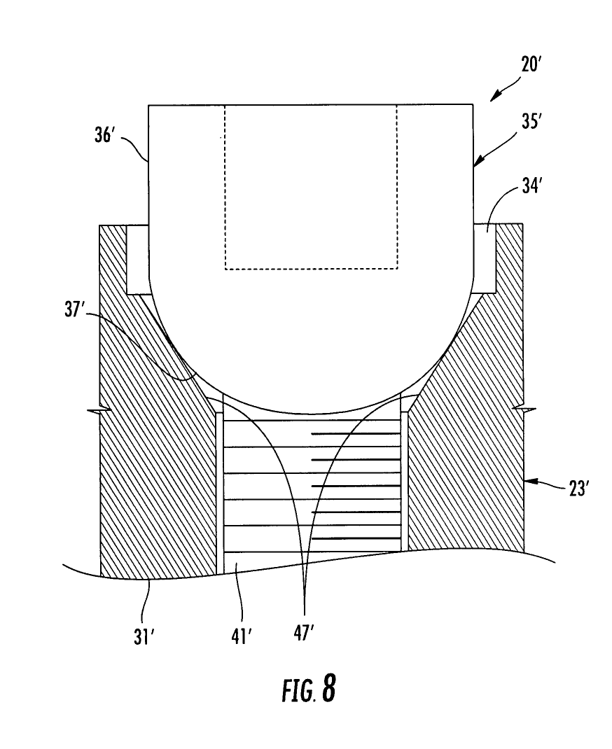

Another embodiment of the seat tube clamp 20′ is now understood with reference to FIG. 8. In this embodiment, the concave upper surface 47′ that engages the convex lower surface 37′ of the enlarged head 36′ is provided by adjacent integrally formed portions of the clamp body 23′ defining the enlarged fastener head-receiving passageway 34′. In other words, the function of the shaped washer is provided by the integrally formed concave upper surface 47′ of the clamp body 23′ so that a separate shaped washer is not needed as will be appreciated by those skilled in the art.

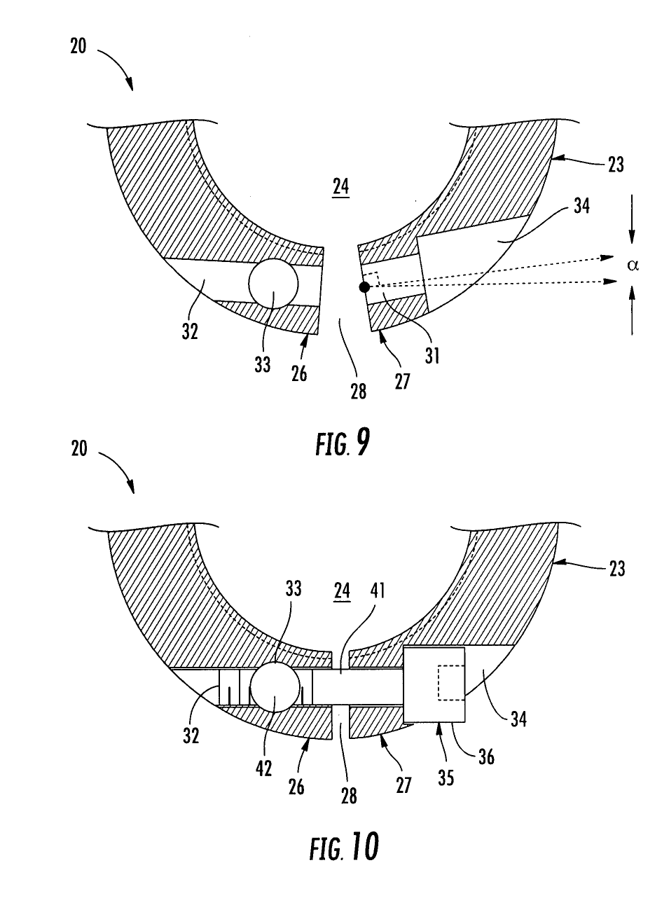

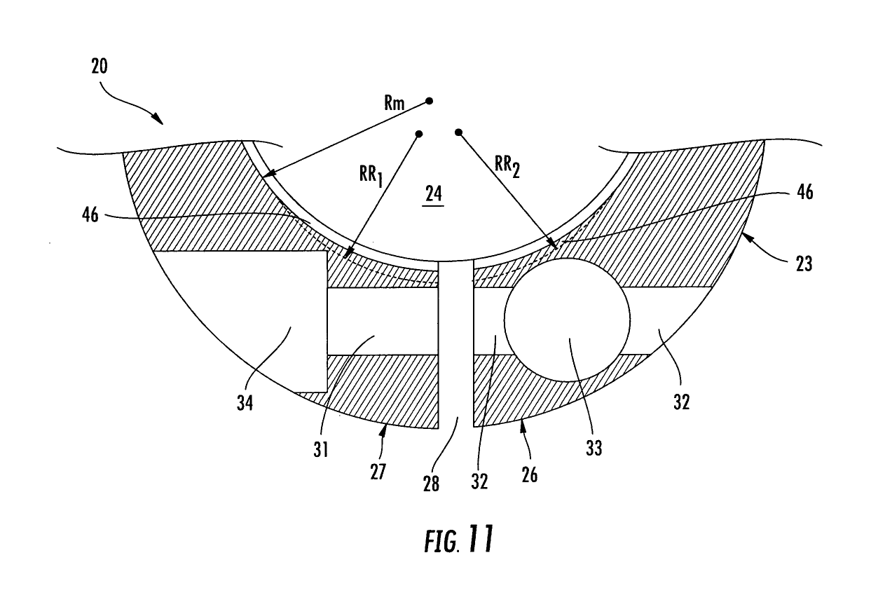

Referring now to FIGS. 9 and 10, another advantageous feature related to the reduction of binding is now described. More particularly, the first and second shaft-receiving passageways 31, 32 and the fastener head-receiving passageway 34 of the bicycle seat tube clamp 20 are canted at an angle α with respect to a centerline therethrough prior to tightening of the fastener (FIG. 9). The angle α may be in a range of about 0.5 to 5 degrees, and a typical value may be about 1.5 degrees. As the fastener 35 is tightened to the position shown in FIG. 10, the canted passageways 31, 32 align with respect to centerline to advantageously prevent or reduce the fastener binding within the passageways thus resulting in smoother tightening and full application of the overall gripping power. The canted passageways 31, 32 and head-receiving passageway 34 may also allow for narrower passageways that may be desirable since larger passageways may otherwise weaken the clamp.

Yet another advantageous feature is also explained with reference to FIG. 11. The first and second clamp ends 26, 27 further have respective interior relief areas 46. Each of the relief areas 46 defines a respective discontinuity with adjacent portions of the clamp body 23. The relief areas 46 allow the seat clamp 20 to be tightened around a seat tube 21 and seat post 22 (FIG. 1) while reducing a likelihood of “biting” or damage to the seat tube, and also to the underlying seat post. This may allow the clamp 20 to be used with different material seat tubes such as, carbon fiber for road bikes, for example.

The main radius Rm has a size corresponding to the opening 24. The relief radii, RR1 and RR2, are each offset from the axis of the main radius Rm by an offset distance. In other embodiments, these offset distances could be different from one another. Further details regarding the relief areas 46 as well as a discussion of dual canted passageways for a clamp for a bicycle steerer tube, may be found in Published U.S. Patent Application No. 2002/10148323, assigned to the assignee of the present application, and the entire contents of which are incorporated herein by reference.

Referring again to FIGS. 1-4, a method aspect is directed to making the bicycle seat tube clamp 20 for clamping an open upper end of the seat tube 21 of a bicycle onto a bicycle seat post 22 positioned therein. The method comprises forming a clamp body 23 to have an opening therethrough 24 for receiving the upper end of the seat tube 21 of the bicycle, and a radially inwardly extending projection 25 for engaging the upper end of the seat tube 21. The clamp body 23 is also formed to have a separation 28 that defines first 26 and second 27 opposing clamp ends.

The method also comprises forming first 31 and second 32 aligned fastener shaft-receiving passageways in the first 26 and second 27 opposing clamp ends. A nut-receiving passageway 33 is also formed to intersect the first fastener shaft-receiving passageway 31 in the first clamp end 26. The nut-receiving passageway 33 is formed to have at least a partial cylindrical shape. An enlarged fastener head-receiving passageway 34 aligned with the second fastener shaft-receiving passageway 32 in the second clamp end 27 is also formed.

The method also includes providing a fastener 35 that comprises an enlarged head 36 to be positioned in the enlarged fastener head-receiving passageway 34 and has a convex surface 37. The fastener 35 also includes a shaft 41 extending outwardly from the enlarged head 36 and positioned to extend through the first 31 and second 32 fastener shaft-receiving passageways. A shaped washer 45 is also included with the fastener 35 to surround the shaft 41 and has an upper concave surface 47 to engage the convex lower surface 37 of the enlarged fastener head 36. The fastener 35 also includes a nut 42 to be positioned in the nut-receiving passageway 33 and to engage the shaft 41. The nut 42 has at least a partially cylindrical shape. In other embodiments, the shaped washer 45 may be replaced by the concave upper surface 74′ formed by adjacent portions of the clamp body 23′ (FIG. 8).

Many modifications and other embodiments of the invention will come to the mind of one skilled in the art having the benefit of the teachings presented in the foregoing descriptions and the associated drawings. Accordingly, it is understood that the invention is not to be limited to the illustrated embodiments disclosed, and that other modifications and embodiments are intended to be included within the spirit and scope of the appended claims.

That which is claimed is:

1. A bicycle seat tube clamp for clamping an open upper end of a seat tube of a bicycle onto a bicycle seat post positioned therein, the bicycle seat tube clamp comprising:
a clamp body having an opening therethrough for receiving the upper end of the seat tube of the bicycle;
at least one radially inwardly extending projection carried by said clamp body for engaging the upper end of the seat tube;
said clamp body having a separation therein defining first and second opposing clamp ends;
said first and second opposing clamp ends having respective first and second aligned fastener shaft-receiving passageways therein;
said first clamp end further having a nut-receiving passageway intersecting the first fastener shaft-receiving passageway, said nut-receiving passageway having at least a partial cylindrical shape;
said second clamp end further having an enlarged fastener head-receiving passageway aligned with the second fastener shaft-receiving passageway; and
a fastener comprising
an enlarged head positioned in the enlarged fastener head-receiving passageway and having a convex surface,
a shaft extending outwardly from said enlarged head and positioned to extend through the first and second fastener shaft-receiving passageways,
a shaped washer surrounding said shaft and having a concave upper surface engaging the convex lower surface of said enlarged fastener head, and
a nut positioned in the nut-receiving passageway and engaging said shaft, said nut having at least a partially cylindrical shape.

2. The bicycle seat tube clamp according to claim 1 wherein the convex lower surface of said enlarged head has a spherical shape; and wherein the concave upper surface of said shaped washer has a conical shape.

3. The bicycle seat tube clamp according to claim 1 wherein said clamp body has a circular perimeter; and wherein the opening through said clamp body is offset from a center defined by the circular perimeter so that said first and second clamp ends each has an enlarged thickness.

4. The bicycle seat tube clamp according to claim 1 wherein the first and second shaft-receiving passageways are canted with respect to a centerline therethrough prior to tightening of said fastener.

5. The bicycle seat tube clamp according to claim 1 wherein said first and second clamp ends each further has a respective interior relief area.

6. The bicycle seat tube clamp according to claim 1 wherein said at least one radially inwardly extending projection comprises a ring having a separation therein aligned with the separation in said clamp body.

7. The bicycle seat tube clamp according to claim 1 wherein the nut-receiving passageway comprises a blind opening.

8. A bicycle seat tube clamp for clamping an open upper end of a seat tube of a bicycle onto a bicycle seat post positioned therein, the bicycle seat tube clamp comprising:
a clamp body having an opening therethrough for receiving the upper end of the seat tube of the bicycle;
at least one radially inwardly extending projection carried by said clamp body for engaging the upper end of the seat tube;
said clamp body having a separation therein defining first and second opposing clamp ends;
said first and second opposing clamp ends having respective first and second aligned fastener shaft-receiving passageways therein;
said first clamp end further having a nut-receiving passageway intersecting the first fastener shaft-receiving passageway, said nut-receiving passageway having at least a partial cylindrical shape;
said second clamp end further having an enlarged fastener head-receiving passageway aligned with the second fastener shaft-receiving passageway and having a concave upper surface; and
a fastener comprising
an enlarged head positioned in the enlarged fastener head-receiving passageway and having a convex surface engaging the convex upper surface of the enlarged fastener head-receiving passageway,
a shaft extending outwardly from said enlarged head and positioned to extend through the first and second fastener shaft-receiving passageways,
a nut positioned in the nut-receiving passageway and engaging said shaft, said nut having at least a partially cylindrical shape.

9. The bicycle seat tube clamp according to claim 8 wherein the convex lower surface of said enlarged head has a spherical shape; and wherein the concave upper surface of the enlarged fastener head-receiving passageway has a conical shape.

10. The bicycle seat tube clamp according to claim 8 wherein said clamp body has a circular perimeter; and wherein the opening through said clamp body is offset from a center defined by the circular perimeter so that said first and second clamp ends each has an enlarged thickness.

11. The bicycle seat tube clamp according to claim 8 wherein the first and second shaft-receiving passageways are canted with respect to a centerline therethrough prior to tightening of said fastener.

12. The bicycle seat tube clamp according to claim 8 wherein said first and second clamp ends each further has a respective interior relief area.

13. The bicycle seat tube clamp according to claim 8 wherein said at least one radially inwardly extending projection comprises a ring having a separation therein aligned with the separation in said clamp body.

14. A bicycle seat tube clamp for clamping an open upper end of a seat tube of a bicycle onto a bicycle seat post positioned therein, the bicycle seat tube clamp comprising:
a clamp body having an opening therethrough for receiving the upper end of the seat tube of the bicycle;
said clamp body having a separation therein defining first and second opposing clamp ends;
said first and second opposing clamp ends having respective first and second aligned fastener shaft-receiving passageways therein;
said first clamp end further having a nut-receiving passageway intersecting the first fastener shaft-receiving passageway;
said second clamp end further having an enlarged fastener head-receiving passageway aligned with the second fastener shaft-receiving passageway; and
a fastener comprising
an enlarged head positioned in the enlarged fastener head-receiving passageway,
a shaft extending outwardly from said enlarged head and positioned to extend through the first and second fastener shaft-receiving passageways, and
a nut positioned in the nut-receiving passageway and engaging said shaft;
the first and second shaft-receiving passageways being canted with respect to a centerline therethrough prior to tightening of said fastener.

15. The bicycle seat tube clamp according to claim 14 wherein said clamp body has a circular perimeter; and wherein the opening through said clamp body is offset from a center defined by the circular perimeter so that said first and second clamp ends each has an enlarged thickness.

16. The bicycle seat tube clamp according to claim 14 wherein said first and second clamp ends each further has a respective interior relief area.

17. The bicycle seat tube clamp according to claim 14 further comprising at least one radially inwardly extending projection carried by said clamp body for engaging the upper end of the seat tube.

18. A method for making a bicycle seat tube clamp for clamping an open upper end of a seat tube of a bicycle onto a bicycle seat post positioned therein, the method comprising:
forming a clamp body to have an opening therethrough for receiving the upper end of the seat tube of the bicycle, to have at least one radially inwardly extending projection for engaging the upper end of the seat tube, and to have a separation therein defining first and second opposing clamp ends;
forming first and second aligned fastener shaft-receiving passageways in the first and second opposing clamp ends;
forming a nut-receiving passageway intersecting the first fastener shaft-receiving passageway in the first clamp end, the nut-receiving passageway having at least a partial cylindrical shape;
forming an enlarged fastener head-receiving passageway aligned with the second fastener shaft-receiving passageway in the second clamp end; and
providing a fastener comprising
an enlarged head to be positioned in the enlarged fastener head-receiving passageway and having a convex surface,
a shaft extending outwardly from the enlarged head and positioned to extend through the first and second fastener shaft-receiving passageways,
a shaped washer to surround the shaft and having a concave upper surface to engage the convex lower surface of the enlarged fastener head, and
a nut to be positioned in the nut-receiving passageway and to engage the shaft, the nut having at least a partially cylindrical shape.

19. The method according to claim 18 wherein the convex lower surface of the enlarged head has a spherical shape; and wherein the concave upper surface of the shaped washer has a conical shape.

20. The method according to claim 18 wherein the clamp body has a circular perimeter; and wherein the opening through the clamp body is offset from center defined by the circular perimeter so that the first and second clamp ends each has an enlarged thickness.

21. The method according to claim 18 wherein the first and second shaft-receiving passageways are canted with respect to a centerline therethrough prior to tightening of the fastener.

22. A method for making a bicycle seat tube clamp for clamping an open upper end of a seat tube of a bicycle onto a bicycle seat post positioned therein, the method comprising:
forming a clamp body to have an opening therethrough for receiving the upper end of the seat tube of the bicycle, to have at least one radially inwardly extending projection for engaging the upper end of the seat tube, and to have a separation therein defining first and second opposing clamp ends;
forming first and second aligned fastener shaft-receiving passageways in the first and second opposing clamp ends;
forming a nut-receiving passageway intersecting the first fastener shaft-receiving passageway in the first clamp end, the nut-receiving passageway having at least a partial cylindrical shape;
forming an enlarged fastener head-receiving passageway aligned with the second fastener shaft-receiving passageway in the second clamp end and having a concave upper surface; and
providing a fastener comprising
an enlarged head to be positioned in the enlarged fastener head-receiving passageway and having a convex lower surface to engage the concave upper surface of the enlarged fastener head-receiving passageway,
a shaft extending outwardly from the enlarged head and positioned to extend through the first and second fastener shaft-receiving passageways, and
a nut to be positioned in the nut-receiving passageway and to engage the shaft, the nut having at least a partially cylindrical shape.

23. The method according to claim 22 wherein the convex lower surface of the enlarged head has a spherical shape; and wherein the concave upper surface of the enlarged fastener head-receiving passageway has a conical shape.

24. The method according to claim 22 wherein the clamp body has a circular perimeter; and wherein the opening through the clamp body is offset from center defined by the circular perimeter so that the first and second clamp ends each has an enlarged thickness.
